(19) United States
(12) Patent Application Publication
(10) Pub. No.: US 2008/0114646 A1
(43) Pub. Date: May 15, 2008

(54) Method and System for Facilitating a Fantasy Sports Contest at the Point of Sale

(76) Inventor: Gary S. Ash, Baltimore, MD (US)

Correspondence Address: JOHN ALEXANDER GALBREATH, 2516 CHESTNUT WOODS CT, REISTERSTOWN, MD, 21136, US

(21) Appl. No.: 11/560,105

(22) Filed: Nov. 15, 2006

(51) Int. Cl. G06Q 30/00

(52) U.S. Cl. 705/14

(57) ABSTRACT

A method for facilitating a contest, promotion, or other activity is disclosed, wherein the activity participant receives an access code at the point of sale—either by receiving a magnetic card or other portable electronically-readable device with the access code thereon, or via communication with the participant's own portable electronically-readable device. The point of sale merchant “activates” the access code given to the participant, thus enabling the participant to use the access code to log onto a secure hosted Internet site and register for the activity. The participant then engages in the activity, and returns to the point of sale—either with the magnetic card or other portable electronically-readable device if he received one, or with his own portable electronically-readable device—to redeem an incentive or award related to the activity.

### BACKGROUND

1. Field of the Invention

The present invention relates to contests, promotions, etc. that involve interaction at the point of sale (POS) of a product or service.

2. Description of the Related Art

Fantasy sports are known in the art. The concept of fantasy sports originated in 1979. Initially, the concept was known as a Rotisserie Baseball League in which baseball fans competed in friendly ‘fantasy’ leagues using the real life statistics of professional baseball players, however the concept gradually spread to include football, hockey, basketball and various other sports. This concept is known today as ‘Fantasy Sports’.

The concept of fantasy sports is further advanced by U.S. Pat. No. 4,918,603 to Hughes. This invention first evolves the concept of fantasy sports by providing a method of and apparatus for playing a football game, using a computer to calculate football statistics.

U.S. Pat. No. 5,018,736 to Pearson discloses an interactive game system and method, and further advances the concept of fantasy sports by recognizing the need for a central controller to help organize the data and provide an interface to promote competition among the participants.

U.S. Pat. No. 6,371,855 to Gavriloff discloses a unique method of playing fantasy sports by using other variables and rules to determine results. Gavriloff combines such factors as performance and market value of participant's players and uses data that correlates real time value of players as it fluctuates during the season. In essence, Gavriloff's idea is another way of operating a fantasy sports contest in a more detailed competitive format.

Point-of-sale contests are also known in the art, including contests or promotions in which a plain (non-electronic) card is given to a participant at the point of sale. The participant then performs an activity such as “scratching off” a portion of the card to reveal a prize or award, and return to the point of sale with the card to redeem the award. Prior art is also known for certain methods of activating, issuing and redeeming magnetic cards at the point of sale. Examples of different types of stored value cards include promotional types such as loyalty cards and gift cards or financial types such as bankcards or non-bank cards including all types of credit cards and debit cards.

Thus, prior art exists that is related to the separate concepts of fantasy sports and point of sale technology. However, Applicant is aware of no such prior art in which facilitating a fantasy sports contest is dependent and used in conjunction with a point of sale device at the point of sale terminal. The current invention illustrates a method in which a magnetic card or other portable electronically-readable device is activated at the point of sale, then requires participant to engage in a fantasy sports contest or activity, and then requires the participant to return to the point of sale to redeem a predetermined or collective participation result determined award. In short, fantasy sports is being used as a promotional vehicle for generating traffic to the point of sale, while providing the contest administrator the ability to gather, analyze and use the data as it relates to their business. The object is to help create customer relationships; to achieve their goal the contest administrator, in essence provides the participants an interactive forum through fantasy sports.

### SUMMARY OF THE INVENTION

The invention is a method for facilitating a contest, promotion, or other activity wherein the activity participant receives an access code at the point of sale—either by receiving a magnetic card or other portable electronically-readable device with the access code thereon, or via communication with the participant's own portable electronically-readable device. The point of sale merchant “activates” the access code given to the participant, thus enabling the participant to use the access code to log onto a secure hosted Internet site and register for the activity. The participant then engages in the activity, and returns to the point of sale—either with the magnetic card or other portable electronically-readable device if he received one, or with his own portable electronically-readable device—to redeem an incentive or award related to the activity.

The activity may be, by way of non-limiting example, a fantasy sports contest in which the participant selects real-life players to form a team which competes against other such teams selected by the POS merchant, a third party managing the method, or other participants. The results of the contest, and thus the incentives or awards given to the participants, can either be determined by the performances of the selected players in real-life games, or pre-determined before the real-life games begin.

It is therefore an object of the present invention to provide a secure method and system for operating a point-of-sale contest or promotion using portable electronically-readable devices such as magnetic cards, contactless “passes”, smart cards, cell phones or other communications devices enabled for communication with merchant point of sale devices.

It is a further object of the invention to provide a secure method and system for operating a point-of-sale contest or promotion using the Internet to facilitate participant registration and contest activity.

It is a further object of the invention to provide an easy way to redeem awards/incentives related to a contest or promotion run by or on behalf of a merchant.

It is a further object of the invention to provide a method and system to increase merchant sales using any desired type of contest or promotion, including the fantasy sports contests popular with many consumers.

Further objects and advantages of the invention will become apparent from a consideration of the ensuing description and drawings.

### DESCRIPTION OF THE DRAWINGS

FIG. 1 is a flowchart showing the basic steps in the inventive method.

FIG. 2 is a flowchart illustrating the inventive method as applied to a fantasy sports contest.

FIG. 3 is a diagram illustrating the components of the system through which the method operates, including the host computer, the point of sale terminal, and the means by which participants access the Internet site and software application that manages the contest.

### DETAILED DESCRIPTION OF THE INVENTION

The following provides a list of the reference characters used in the drawings:
10. Initial visiting step
11. Issuing step
12. Registering step
13. Engaging step
14. Award determining step
15. Redeeming step
16. Participant selecting step
17. Merchant selecting step
18. Game playing step
19. Computer
20. Participant access means
21. Software application
22. Point of sale terminal
23. Web application
24. Merchant-issued portable electronically-readable device
25. Access code
26. Activation step
27. Participant-supplied portable electronically-readable device

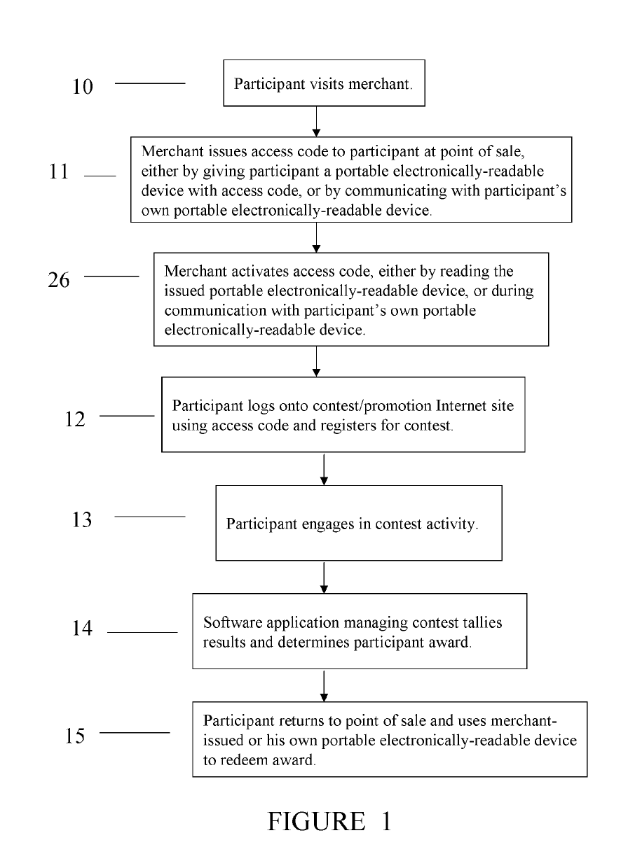

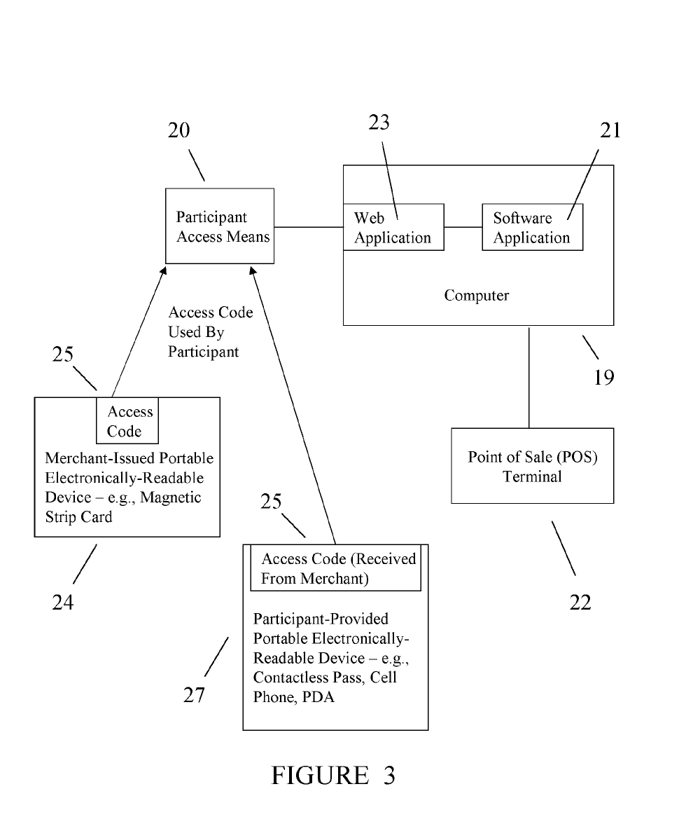

FIG. 1 is a flowchart showing the basic steps in the inventive method. The system components through which the method operates are also mentioned in the ensuing description, and are shown in FIG. 3. The first step in the method is initial visiting step 10, wherein the contest/promotion participant visits the merchant. As part of a purchase transaction between the participant and the merchant—or alternatively without a purchase transaction being required—in issuing step 11 the merchant gives a merchant-issued portable electronically-readable device 24 to the participant (e.g., a card with a magnetic strip), along with an access code 25. Access code 25 may be printed on or attached to merchant-issued portable electronically-readable device 24 and imbedded in the magnetic strip or other electronically-readable component of said device, or alternatively access code 25 can be provided using separate means. Alternatively, the merchant can issue the access code to the participant by communicating with participant-supplied portable electronically-readable device 27. As an illustration of this latter scenario, a participant visiting the merchant places participant-supplied portable electronically-readable device 27 in proximity to the merchant's point of sale terminal 22, a reading device associated with point of sale terminal 22, or a separate scanning/card reading device dedicated to the contest. Participant-supplied portable electronically-readable device 27 then communicates with the system via the merchant's point of sale device, and the system sends access code 25 to the participant via a voice message, text message, email, or other communication.

Instead of a magnetic strip card, the portable electronically-readable device (the device issued by the merchant, or the participant's own device) may take another form such as those commonly known as radio frequency identification (RFID) cards, contactless “passes”, loyalty cards, smart cards, etc. The portable electronically-readable device may also be a mobile/wireless device such as a cell phone or personal digital assistant (PDA), enabled to communicate with the merchant's point of sale device.

In activating step 26, the merchant activates access code 25, either by reading merchant-issued portable electronically-readable device 24, or during the aforesaid communication with participant-supplied portable electronically-readable device 27. Activation accomplishes several things: first, it increases the security of the method and guards against theft of unissued cards. Second and relatedly, activation allows the system to know what access codes have been issued, so that when the participant logs onto the contest Internet site, the system is enabled to accept the participant's access code as a valid code. For example, if someone stole an unissued card from the merchant and attempted to log onto the contest Internet site using the stolen card's access code, the system would block the log-in because the card/access code had not been activated.

Third, activation allows for better tracking of contest participation and operation. For example, it allows the system to know which access codes, and how many access codes, were issued from a particular merchant location during a given time period, whether a participant redeemed his award from the same merchant location that issued the access code, etc. This can engender competition among different locations of a merchant participating in the contest, and/or among different merchants participating in a multi-merchant contest.

It should be understood that in the case where the merchant gives the participant a portable electronically-readable device, the merchant can activate the device before giving it to the participant—that is, activating step 26 can come before issuing step 11.

In registering step 12, the participant uses access code 25 to log onto a contest Internet site run by a web application 23 residing on a computer 19. Once logged on, the participant registers himself or herself to take part in the contest or promotion. It should be noted that registering step 12 can involve the participant merely entering access code 25 and engaging in the required activity (anonymous participation), or alternatively registering step 12 can involve the participant entering many different forms of information about himself or herself (non-anonymous participation). With non-anonymous participation, it can be appreciated that the information entered by the participant would be useful for any number of marketing/analysis purposes.

In engaging step 13, while on the Internet site the participant engages in whatever activity the contest or promotion requires. In award determining step 14, a software application 21 managing the contest/promotion tallies the contest results, determines the amount and nature of the awards earned by the contest participants, and makes that information available to the merchant for use in redeeming step 15.

In redeeming step 15, the participant returns to the point of sale and uses the magnetic card or other merchant-issued portable electronically-readable device 24, or participant-supplied portable electronically-readable device 27, to redeem his/her award. This can be done, for example, by presenting the magnetic card to the merchant when making a purchase at the point of sale. The merchant scans the magnetic card or other portable device—using either its point of sale terminal 22, a reading device associated with point of sale terminal 22, or a separate scanning/card reading device dedicated to the contest—and thereby identifies the award connected with the card. Or alternatively, in the case where the participant used his own portable electronically-readable device 27 to obtain an access code, when returning the participant places his portable electronically-readable device 27 in proximity to the merchant's point of sale terminal 22, a reading device associated with point of sale terminal 22, or a separate scanning/card reading device dedicated to the contest.

It can be appreciated that the merchant identifies the award connected with the card by comparing access code 25 associated with merchant-issued portable electronically-readable device 24 (or participant-supplied portable electronically-readable device 27 as the case may be) with the information supplied by software application 21 in award determining step 14 above. The identification process is done automatically, by the point of sale scanning/card reading device either querying the software application or, in the case where the software application downloads the award information to the merchant's point of sale device, consulting the award information it has already received.

As just a few examples of award possibilities, if the merchant is a fast-food restaurant, the award might be $1.00, $1.50 off any menu item, $2.00 off a specific menu item, and so on. The award can be given to the participant either by deducting it from the participant's bill, or by simply giving it to the participant in the case where a subsequent purchase is not required to redeem the award.

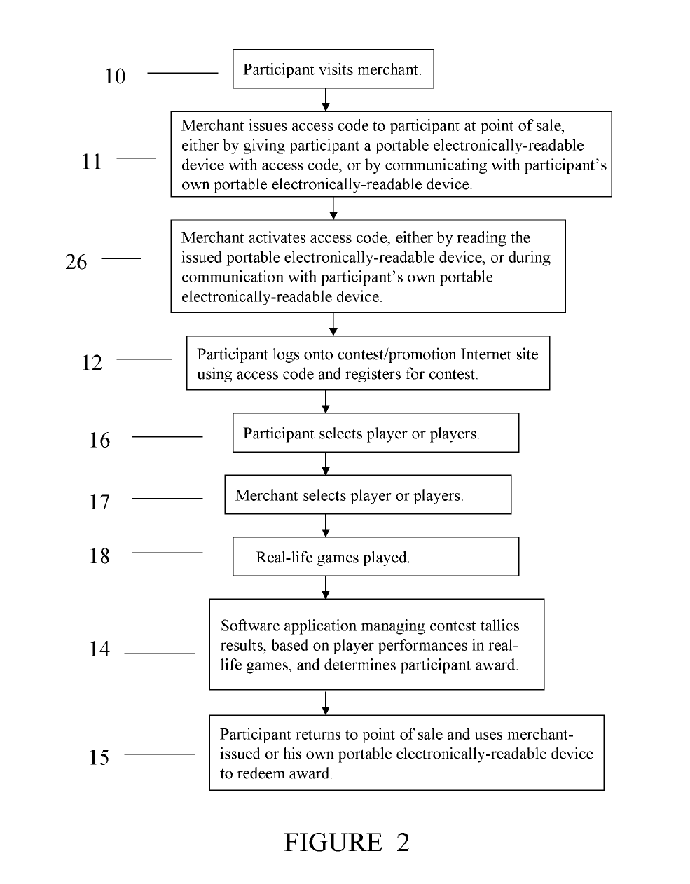

FIG. 2 is a flowchart illustrating the inventive method as applied to a fantasy sports contest. Initial visiting step 10, issuing step 11, activating step 27, and registering step 12 are essentially the same in FIGS. 1 and 2; however, FIG. 2 provides more detail in the case wherein the contest is a fantasy sports contest. Specifically, after registering at the contest Internet site, the participant engages in contest activity in participant selecting step 16 by selecting real-life players in a given sport—either individually, as in tennis, or collectively, as in a team sport like football.

As an example, where the given sport is football, the web application 23 running the Internet site allows the participant to select a team of players encompassing each offensive and defensive position from the players currently in the National Football League. It should be understood that web application 23 can be any of several such applications that are known in the realm of online fantasy sports, or can comprise features taken from a combination of these known web applications.

In addition to the participant selecting his/her player or players, in merchant selecting step 17 the merchant (or a third party on the merchant's behalf) selects its own player or players, against whom the participant's player or players will compete. By way of non-limiting example, in the case where a third party selects the merchant's team, a local or national sports or other celebrity can pick the merchant's team. This would increase the attractiveness of the contest to local or national participants.

Continuing with the fantasy sports example shown in FIG. 2, in game playing step 18 real-life games are played. The performance of each real-life player in those games determines the score of the participant versus the merchant, and thus determines the nature of any participant award. For instance, if football is the fantasy sport, then the real-life performance of players in National Football League (NFL) or National Collegiate Athletic Association (NCAA) games would determine the participant score and the amount of any award.

FIG. 2 also has an award determining step 14, similar to that in FIG. 1, wherein software application 21 managing the contest/promotion tallies the contest results, determines the amount and nature of the awards earned by the contest participants, and makes that information available to the merchant. It should be noted that in the fantasy sports realm, there are many different ways to tally the results—that is, there are many different ways to convert the real-life performances of the players into scores for the participant and merchant. Thus, it should be understood that any suitable rule scheme may be used to tally the results. It should also be understood that the contest results, and thus the incentives or awards given to the participants, can either be determined by the performances of the selected players in real-life games, or pre-determined before the real-life games begin.

FIG. 2 also has a redeeming step 15, similar to that discussed above for FIG. 1, wherein the participant returns to the point of sale and uses merchant-issued portable electronically-readable device 24 or participant-supplied portable electronically-readable device 27 to redeem his/her award.

FIG. 3 is a diagram illustrating the components of the system through which the method operates. A computer 19 hosts the Internet site through which participants register and (in the fantasy sports example) select their players. Participant access means 20 is connected in a wired or wireless fashion to computer 19, and allows participants to access web application 23 residing on computer 19. Participant access means 20 can be, by way of non-limiting example, a desktop computer or user terminal, a laptop computer, an Internet-enabled cell phone or personal digital assistant (PDA), or any other suitable communications device.

Software application 21 also resides on computer 19. Software application 21 manages the contest (again, in the fantasy sports example) by storing the player selections associated with each participant, tallying the participant scores by analyzing the performances of the players in the appropriate real-life games, and determining participant awards. Point of sale terminal 22 is also connected in a wired or wireless fashion to computer 19, and can be, again be way of non-limiting example, an electronic register or computer. As discussed above, point of sale terminal 22 (a reading device associated with point of sale terminal 22 or a separate scanning/card reading device dedicated to the contest can also be used) permits the merchant to verify that an award is due a participant, and the amount of that award, when the participant returns to the merchant and presents his/her magnetic card or other portable device.

Merchant-issued portable electronically-readable device 24 is also shown in FIG. 3. As discussed above, merchant-issued portable electronically-readable device 24 can be a magnetic card or any other suitable device. An access code 25 is associated with merchant-issued portable electronically-readable device 24, and is used by the participant to access web application 23 and register for the contest/promotion.

Finally, participant-supplied portable electronically-readable device 27 is also shown in FIG. 3, and is used in the scenario wherein the participant places his own device in proximity to the merchant's point of sale device and thereby receives access code 25. The participant then uses access code 25 to access web application 23 and register for the contest/promotion. On the participant's subsequent return to the point of sale, participant-supplied portable electronically-readable device 27 is also used to redeem an award, as described above.

### CONCLUSIONS, RAMIFICATIONS, AND SCOPE

While the above descriptions contain many specificities, these shall not be construed as limitations on the scope of the invention, but rather as exemplifications of embodiments thereof. Many other variations are possible without departing from the spirit of the invention. Examples of just a few of the possible variations follow:

In the fantasy sports example described above, in addition to the participant competing against the merchant's player or team (or a player or team selected by a third party on behalf of the merchant), the participant can also compete against other participants in order to obtain awards or incentives. In such an alternative scenario, better-scoring participants would be given awards based on whatever rule scheme is in place for the contest or promotion. In another alternative scenario, an element of collective performance of all the participants or a portion thereof (in fact, up to 100% collective) can be included in the award determination, rather than just an individual participant's performance determining his award.

A “readable” device as used herein is considered to be a broad term encompassing any device that can be scanned, run through a card reader, or communicated with in any fashion, including by active or passive means.

Any suitable wired or wireless communication means can be used to accomplish the various communications described above, including but not limited to standard protocols known in the art.

The access code can be any alphanumeric code, or other string of characters or symbols.

The contest/promotion rule scheme can be anything the merchant desires—the point is that the participant competes for or otherwise obtains an award or incentive, and then returns to the point of sale and uses the portable electronically-readable device issued by the merchant, or his own portable electronically-readable device to redeem the award or incentive. Said another way, the contest or promotion does not have to be a fantasy sports contest, but can instead be another type of contest or promotion. It can also be a sweepstakes or other type of contest wherein the participant does not have to engage in any activity beyond registering for the contest.

The contest can be free to the participants, or alternatively the participants can pay a certain sum of money to participate. If the participants pay money to participate, this money may or may not be donated to charity. For example, in the celebrity team-picker scenario described above, the money may be donated to the celebrity's favorite charity.

The portable electronically-readable device can be used more than once. For example (in the fantasy sports scenario), after the participant obtains an award based on the performance of his/her players in one real-life game, the participant can obtain another award based on the performance of his/her players in a subsequent real-life game, and the participant can return to the merchant to redeem this subsequent award using the same portable electronically-readable device. Also, in either a fantasy sports contest or another type of contest, the contest results, and thus the awards, can be cumulative—that is, they can be based on cumulative outcomes over multiple rounds of the contest.

The device used for receiving the access code from the merchant can be the same as the participant access means used to access the web application. As just one example, the participant can use an Internet-enabled cell phone or PDA to communicate with a point of sale device and receive the access code, and then use the same device to access the web application.

The participant can access the web application again after the initial access, for example to modify his/her selection of players in a fantasy sports contest, if contest rules permit such modification.

“Returning to the point of sale” does not necessarily mean returning to the same location of the merchant (i.e., the same store, restaurant, etc.), or even the same chain of locations owned by the merchant. Instead, the method contemplates a scenario wherein a participant can redeem his/her award at a different location of the merchant, or at another merchant cooperating with the first merchant in the contest or promotion.

The participant does not necessarily have to be the one who personally redeems the award or incentive. The method contemplates the situation wherein the participant gives the issued portable electronically-readable device to another person who then redeems the award.

The computer can both host the Internet site (operate the web application) and operate the software application managing the contest or promotion, as shown and discussed—or alternatively, the Internet site can be hosted by a separate server communicating with said computer and/or the point-of-sale device. In addition, the functions done by the web application and the software application managing the contest or promotion can be combined, so that a single software application performs both functions. In such a situation, one part of the combined software application can be considered the “first software application” running the web application, and another part of the combined software application can be considered the “second software application” managing the contest or promotion. In addition, the software application managing the contest can also reside on the point-of-sale terminal or other point-of-sale device, which as discussed earlier can be a computer.

Although for simplicity's sake the above description often refers to a single participant, the system and method of the invention can of course handle multiple participants in the contest/promotion.

Accordingly, the scope of the invention should be determined not by the embodiments illustrated, but by the appended claims and their legal equivalents.

What is claimed is:

1. A method for facilitating a point of sale promotion, comprising the steps of:
a) issuing an access code to a participant at the point of sale, by providing a portable electronically-readable device having an associated access code to said participant or by communicating with a participant-provided electronically-readable device;
b) activating said access code, thus enabling said participant to access and register for said promotion over a network using said access code;
c) determining an award or incentive to be given to said participant; and
d) redeeming said award or incentive upon said participant's return to the point of sale and presentation of said issued or participant-provided portable electronically-readable device, by reading said issued or participant-provided portable electronically-readable device, ascertaining said participant's determined award or incentive, and providing said award or incentive to said participant.

2. The method of claim 1, wherein said promotion is a fantasy sports contest.

3. The method of claim 2, wherein said method also includes the step of the participant selecting at least one real-life player in a sport or other activity.

4. The method of claim 3, wherein said award or incentive is determined based on the performance of said participant's at least one player in a real-life game or other activity.

5. The method of claim 3, wherein said method also includes the step of a merchant or third party selecting at least one real-life player in a sport or other activity.

6. The method of claim 5, wherein said award or incentive is determined based on the performance of said participant's at least one player and said merchant or third party's at least one player in a real-life game or other activity.

7. The method of claim 1, wherein said issued or participant-provided portable electronically-readable device is a card having a magnetic strip thereon.

8. The method of claim 7, wherein said access code is also visible on said card.

9. The method of claim 1, wherein said issued or participant-provided portable electronically-readable device is a contactless communications device.

10. The method of claim 1, wherein said activating step enables said participant to access and register for said promotion by visiting an Internet site.

11. A system for facilitating a point of sale promotion, comprising:
a) a portable electronically-readable device and an associated access code;
b) promotion participant access means for allowing a promotion participant to register for said promotion over a network using said access code;
c) a first software application that communicates with said promotion participant access means and manages said registration; and
d) a second software application that communicates with said first software application, determines an award or incentive to be given to said promotion participant, and communicates with a point of sale device that reads said portable electronically-readable device and ascertains said promotion participant's determined award or incentive from said communication between said point of sale device and said second software application.

12. The system of claim 11, wherein said system also comprises said point of sale device.

13. The system of claim 11, wherein said promotion participant access means is a computer.

14. The system of claim 11, wherein said promotion participant access means is an Internet-enabled device.

15. The system of claim 11, wherein said portable electronically-readable device is a card having a magnetic strip thereon.

16. The system of claim 11, wherein portable electronically-readable device is a contactless communications device.

17. The system of claim 11, wherein said first software application manages an Internet site for said promotion participant registration.

18. The system of claim 11, wherein said promotion is a fantasy sports contest.

19. The system of claim 18, wherein said promotion participant selects at least one real-life player in a sport or other activity.

20. The system of claim 19, wherein said second software application determines said award or incentive based on the performance of said promotion participant's at least one player in a real-life game or other activity.
